(19) United States
(12) Patent Application Publication
(10) Pub. No.: US 2010/0262402 A1
(43) Pub. Date: Oct. 14, 2010

(54) PERFORMANCE EVALUATION DEVICE AND PERFORMANCE EVALUATION METHOD

(75) Inventors: Yuuki FUSE, Kanagawa (JP); Hideki Matsuyama, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/755,071

(22) Filed: Apr. 6, 2010

(30) Foreign Application Priority Data
Apr. 8, 2009 (JP) 2009-093893

(51) Int. Cl. G06F 11/30

(52) U.S. Cl. 702/182

(57) ABSTRACT

A performance evaluation device includes an event counter unit that counts events occurring by execution of an evaluation target program from arrival of a measurement start signal indicating a measurement start point of a measurement section preset to the evaluation target program to arrival of a measurement stop signal indicating a measurement stop point of the measurement section, and an iteration counter unit that counts iterations of the measurement section to be iterated based on at least one of the measurement start signal and the measurement stop signal.

### INCORPORATION BY REFERENCE

This application is based upon and claims the benefit of priority from Japanese patent application No. 2009-093893, filed on Apr. 8, 2009, the disclosure of which is incorporated herein in its entirety by reference.

### BACKGROUND

1. Field of the Invention

The present invention relates to a performance evaluation device and a performance evaluation method.

2. Description of Related Art

A performance evaluation device that evaluates performance of a program is sometimes mounted on a microprocessor today for the purpose of program performance improvement, debugging or the like. By incorporating a processor into the performance evaluation device, it is possible to measure the number of occurrences of events in the processor during execution of a program. Based on a measurement result of the performance evaluation device, a program developer can conduct work such as program performance improvement and debugging.

A program involves a large number of processing that iterates over a specific section (loop, function etc.). During the iterations of a specific section of a program, however, there is a case where different processing is executed due to a difference in calculation result, an occurrence of an interrupt from the outside of a processor or the like. Thus, even when iterating over a specific section, performance measured in each iteration is not necessarily the same.

Japanese Unexamined Patent Application Publication No. 2006-293427 discloses a software evaluation device capable of measuring the processing time of a section determined by given start address and stop address of software without through an external device. In this device, a first comparator issues a start command to a time measurement device when a count value of a running PC matches a start address value. Then, a second comparator issues a stop command to the time measurement device when the count value of the running PC matches a stop address value. Upon receiving the stop command from the comparator, the time measurement device immediately stops a time measurement operation and stores a measurement result into a register.

### SUMMARY

As described above, it has now been discovered that, even when iterating over a specific section of a program, performance measured in each iteration is not necessarily the same. In order for further development and improvement of software, it is a prerequisite to appropriately evaluate performance of the software. However, when conducting performance measurement on a measurement target section to be iterated, because a performance measurement device used hitherto does not provide a means of knowing the number of times of passing the measurement target section, a software developer cannot identify how many number of times the measurement target section has been passed when an obtained performance measurement result was made, and it is thus unable to evaluate performance of software appropriately. The number of times of passing the measurement target section cannot be identified also in the case of Japanese Unexamined Patent Application Publication No. 2006-293427.

As obvious from the above description, in order to appropriately evaluate software performance, it is strongly demanded to identify the number of times of passing the measurement target section at the same time as measuring performance when conducting performance measurement by designating a measurement target section for iteration.

A first exemplary aspect of the present invention is a performance evaluation device which includes a first counter unit that counts events occurring by execution of an evaluation target program from arrival of a measurement start signal indicating a measurement start point of a measurement section preset to the evaluation target program to arrival of a measurement stop signal indicating a measurement stop point of the measurement section, and a second counter unit that counts iterations of the measurement section to be iterated based on at least one of the measurement start signal and the measurement stop signal.

By referring to the count value of the second counter unit, it is possible to identify the number of times of passing the measurement target section during measurement of performance.

A second exemplary aspect of the present invention is a semiconductor integrated device which includes a central processing unit (CPU) that executes an evaluation target program, a signal generation unit that generates a measurement start signal and a measurement stop signal by detecting a measurement start point and a measurement stop point of a measurement section preset to the evaluation target program, a first counter unit that counts events occurring by execution of the evaluation target program from arrival of the measurement start signal to arrival of the measurement stop signal, and a second counter unit that counts iterations of the measurement section to be iterated based on at least one of the measurement start signal and the measurement stop signal.

A third exemplary aspect of the present invention is a performance evaluation method which includes counting events occurring by execution of an evaluation target program from arrival of a measurement start signal indicating a measurement start point of a measurement section preset to the evaluation target program to arrival of a measurement stop signal indicating a measurement stop point of the measurement section, and counting iterations of the measurement section to be iterated based on at least one of the measurement start signal and the measurement stop signal.

According to the exemplary aspects of the present invention described above, it is possible to identify the number of times of passing a measurement target section at the same time as obtaining a performance measurement result when conducting performance measurement by designating the measurement target section to be iterated in a program.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a schematic block diagram of a microprocessor according to a first exemplary embodiment of the present invention;

FIG. 2 is a schematic flowchart showing a procedure of performance evaluation of an evaluation target program according to the first exemplary embodiment of the present invention;

FIG. 3 is a schematic timing chart showing an operation of the microprocessor according to the first exemplary embodiment of the present invention;

FIG. 4 is a schematic block diagram of a microprocessor according to a second exemplary embodiment of the present invention; and

FIG. 5 is a schematic timing chart showing an operation of the microprocessor according to the second exemplary embodiment of the present invention.

### DETAILED DESCRIPTION OF THE EXEMPLARY EMBODIMENTS

Exemplary embodiments of the present invention are described hereinafter with reference to the drawings. Each embodiment is simplified for convenience of description. The drawings are given in simplified form by way of illustration only, and thus are not to be considered as limiting the present invention. The drawings are given merely for the purpose of explanation of technological matters, and they do not show the accurate scale or the like of each element shown therein. The same elements are denoted by the same reference symbols, and the redundant explanation is omitted.

### First Exemplary Embodiment

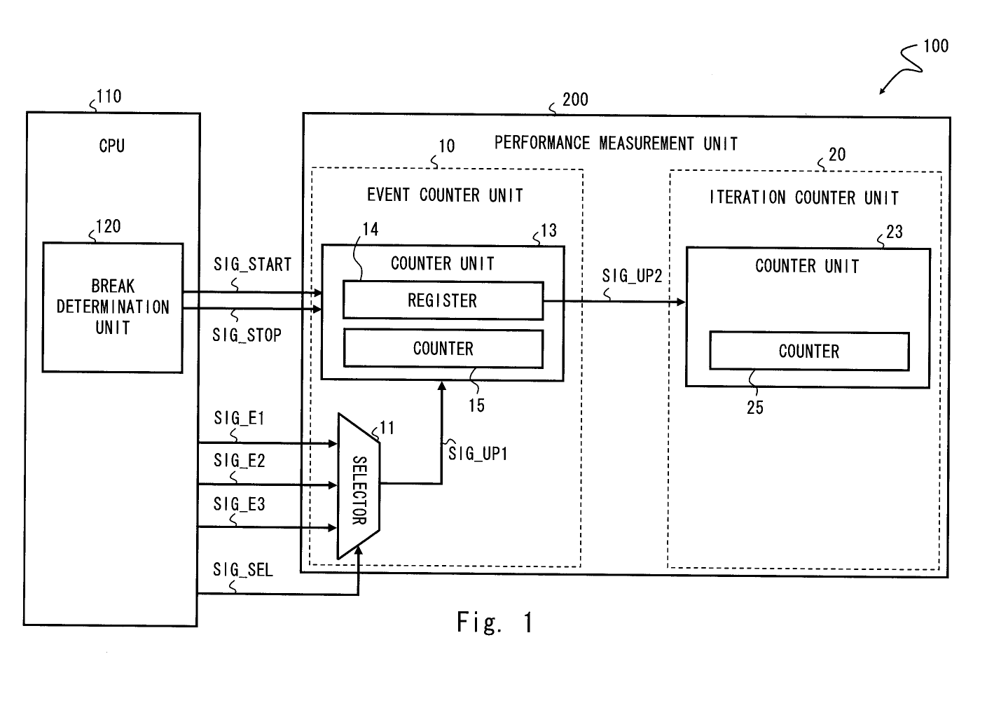

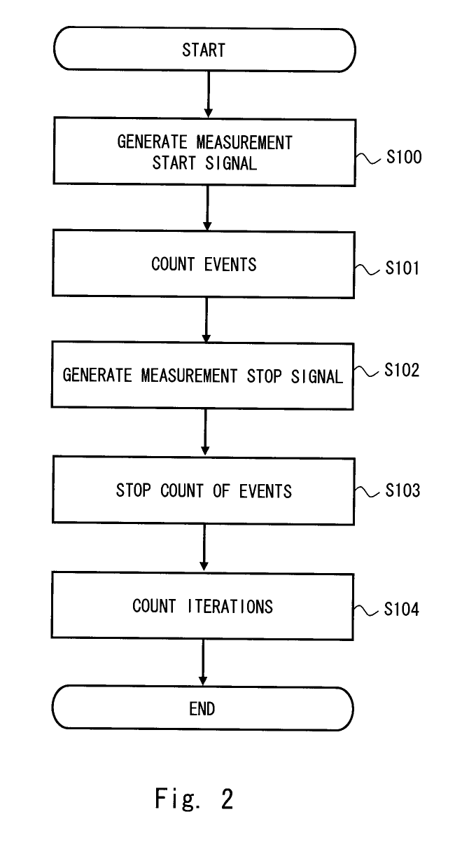

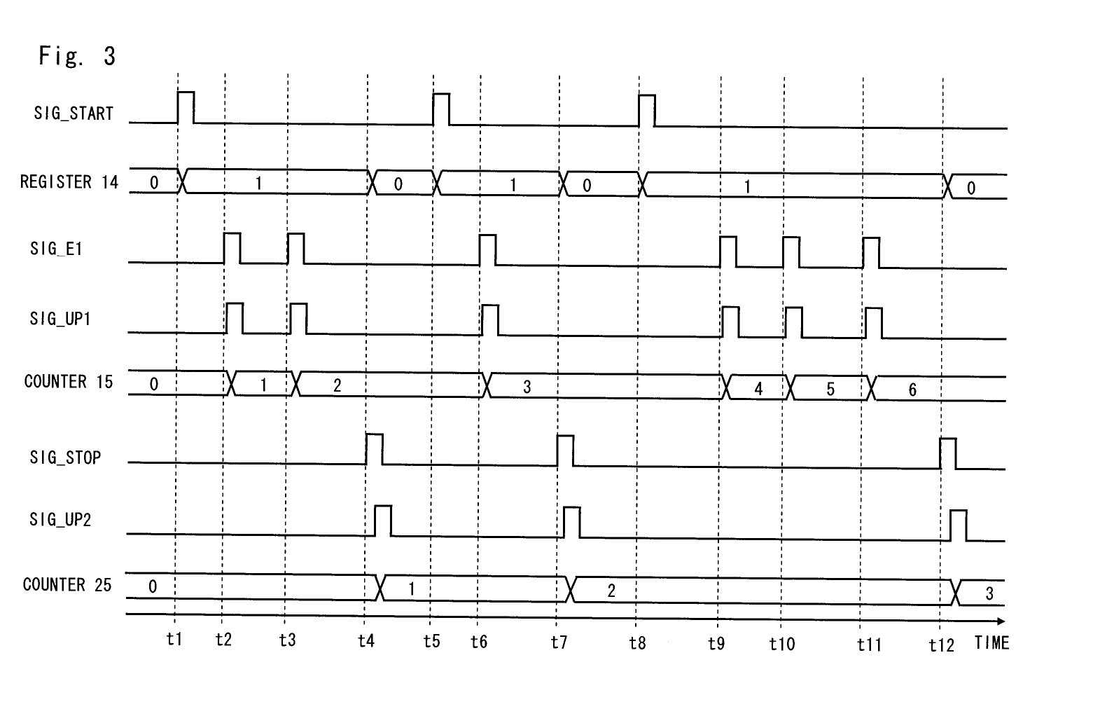

An exemplary embodiment of the present invention is described hereinafter with reference to the drawings. FIG. 1 is a schematic block diagram of a microprocessor. FIG. 2 is a schematic flowchart showing a procedure of performance evaluation of an evaluation target program. FIG. 3 is a schematic timing chart showing an operation of the microprocessor.

Referring to FIG. 1, a microprocessor 100 includes a CPU 110 and a performance measurement unit (performance measurement device) 200. The CPU 110 includes a break determination unit (signal generation unit) 120. The performance measurement unit 200 includes an event counter unit (counter unit) 10 and an iteration counter unit (counter unit) 20. The event counter unit 10 includes a selector 11 and a counter unit 13. The iteration counter unit 20 includes a counter unit 23. The counter unit 13 includes a register 14 and a counter 15. The counter unit 23 includes a counter 25.

A connection relationship among the elements is described hereinbelow. An output of the break determination unit 120 is input to the counter unit 13. An output of the CPU 110 is input to the selector 11 and the counter unit 13. An output of the selector 11 is input to the counter unit 13. An output of the counter unit 13 is input to the counter unit 23. Count values of the counter 15 and the counter 25 are supplied to the CPU 110 or another functional circuit.

The CPU 110 executes a program (evaluation target program). During execution of a program by the CPU 110, various signals (SIG_START, SIG_STOP, SIG_E1, SIG_E2, SIG_E3, SIG_SEL etc.) are transmitted from the CPU 110 to the performance measurement unit 200. If a particular event occurs in the process of executing the program, the CPU 110 outputs event signals SIG_E1 to SIG_E3 to the selector 11. The particular event is memory access, success or failure of branch, interrupt, pipeline install or the like, for example.

The break determination unit 120 is a general debugging mechanism of a microprocessor. The break determination unit 120 determines whether a result generated by executing a program in the CPU 110 satisfies a preset condition or not and, if the condition is satisfied, outputs a signal indicating that the condition is satisfied.

The break determination unit 120 detects a start point of a measurement section to be iterated in a program and generates a signal indicating the start point of the measurement section. When a program counter value matches a predetermined value, the break determination unit 120 outputs a measurement start signal SIG_START to the counter unit 13. Note that, the start point of the measurement section may be detected by a method different from comparison of a program counter value.

The break determination unit 120 further detects a stop point of a measurement section to be iterated in a program and generates a signal indicating the stop point of the measurement section. When a program counter value matches a predetermined value, the break determination unit 120 outputs a measurement stop signal SIG_STOP to the counter unit 13. Note that, the stop point of the measurement section may be also detected by a method different from comparison of a program counter value.

The event counter unit 10 detects start of counting events based on the measurement start signal SIG_START. The event counter unit 10 further detects stop of counting events based on the measurement stop signal SIG_STOP. The event counter unit 10 counts events occurring by execution of a program in the CPU 110 based on the event signals SIG_{— μl to SIG}_E3. The event counter unit 10 outputs a count up signal SIG_UP2 to the iteration counter unit 20 upon update of a stored value of the register 14 from 1 to 0. Alternatively, the event counter unit 10 may be designed in such a way that a count up signal SIG_UP1 is output upon update of a stored value of the register 14 from 0 to 1.

The selector 11 selects and outputs an event signal that is specified by a select signal SIG_SEL transmitted from the CPU 110. For example, when the select signal SIG_SEL is 00, the selector 11 selects and outputs the event signal SIG_E1. When the select signal SIG_SEL is 01, the selector 11 selects and outputs the event signal SIG_E2. When the select signal SIG_SEL is 11, the selector 11 selects and outputs the event signal SIG_E3.

The counter unit 13 updates the count value of the counter 15 based on the count up signal SIG_UP1 according to the stored value of the register 14. A measurement status value that determines the operating state of the counter unit 13 is set to the register 14.

The counter unit 13 sets the stored value of the register 14 to 1 upon receiving the measurement start signal SIG_START. The counter unit 13 sets the stored value of the register 14 to 0 upon receiving the measurement stop signal SIG_STOP.

When the stored value of the register 14 is 1, the counter unit 13 counts the count up signal SIG_UP1 and updates the count value of the counter 15. When the stored value of the register 14 is 0, the counter unit 13 does not execute the count operation.

The iteration counter unit 20 counts the iterations of the measurement section that is iterated in a program based on the count up signal SIG_UP2 output from the event counter unit 10. As described above, the count up signal SIG_UP2 is output from the counter unit 13 in response to the measurement stop signal SIG_STOP or the measurement start signal SIG_START. Thus, it can be comprehended that the iteration counter unit 20 counts the iterations of the measurement section in a program based on the measurement stop signal SIG_STOP or the measurement start signal SIG_START. The counter unit 23 updates the count value of the counter 25 based on the count up signal SIG_UP2.

The counter 15 counts the occurrences of events in the measurement target section to be iterated in an accumulated manner without being reset during measurement by the performance measurement device. Alternatively, the counter 15 may be designed to be reset during measurement by the performance measurement device. In this case, if the event counter unit 10 is designed to reset the counter 15 upon update of the stored value of the register 14 from 0 to 1, the counter 15 operates as a counter that counts the number of events per one passage of the measurement target section to be iterated. The counter 25 counts the iterations of the measurement section without being reset during measurement by the performance measurement device.

An operation of the microprocessor 100 is described hereinafter with reference to FIG. 2. It is assumed that a condition for generating the measurement start signal SIG_START by the break determination unit 120 is preset to the break determination unit 120. The same applies to a condition for generating the measurement stop signal SIG_STOP. It is also assumed that the selector 11 is set to select and output the event signal SIG_E1. Further, it is assumed that the count values of the counter 15 and the counter 25 are set to an initial value 0. Likewise, the stored value of the resister 14 is set to an initial value 0.

First, the measurement start signal SIG_START is generated (S100). Specifically, the break determination unit 120 detects the start position of the measurement section to be iterated, generates the measurement start signal SIG_START and outputs it to the counter unit 13. For example, the break determination unit 120 generates the measurement start signal SIG_START by comparing a program counter value with a predetermined value.

Next, count of events is executed (S101). Specifically, the counter unit 13 sets the stored value of the register 14 to 1 based on the measurement start signal SIG_START. In response thereto, the counter unit 13 updates the value of the counter 15 based on the count up signal SIG_UP1 sequentially output from the selector 11. The events occurring by execution of a program in the CPU 110 are thereby counted.

After that, the measurement stop signal SIG_STOP is generated. Specifically, the break determination unit 120 detects the stop position of the measurement section to be iterated, generates the measurement stop signal SIG_STOP and outputs it to the counter unit 13. For example, the break determination unit 120 generates the measurement stop signal SIG_STOP by comparing a program counter value with a predetermined value.

Then, the count of events is stopped (S103). Specifically, the counter unit 13 sets the stored value of the register 14 to 0 based on the measurement stop signal SIG_STOP. In response thereto, the counter unit 13 stops count-up of events that has been performed.

Further, the iterations are counted (S104). Specifically, the counter unit 13 outputs the count up signal SIG_UP2 to the counter unit 23 upon update of the stored value of the register 14 from 1 to 0. The counter unit 23 updates the count value of the counter 25 based on the count up signal SIG_UP2. The iterations of the measurement section to be iterated can be thereby counted.

During execution of the program, the microprocessor 100 repeatedly executes the steps S100 to S104.

As described earlier, even when iterating a specific section of a program, performance measured in each iteration is not necessarily the same. In order for further development and improvement of software, it is a prerequisite to appropriately evaluate performance of the software. Performance of software cannot be appropriately evaluated without knowing the number of times of passing the measurement target section as well as a performance measurement result of the measurement target section to be iterated.

In this exemplary embodiment, the iterations of the measurement target section to be iterated are obvious by referring to the count value of the counter 25. Therefore, when measuring performance of a program while iterating over a common measurement section, for example, it is possible to distinguish a difference in the number of passing the measurement target section between a performance measurement result of the first iteration and a performance measurement result of the second iteration. Further, a program developer can obtain an average value of the number of occurrences of events in each measurement section by dividing the number of counts of events by the number of iterations of the measurement section. It is thereby possible to appropriately evaluate performance of software and appropriately enhance development and improvement of the software.

The operation of the microprocessor 100 is additionally described with reference to FIG. 3. Although each signal is binarized for convenience of explanation, it may be a digital signal having a logical value with a plurality of bits.

At time t1, the measurement start signal SIG_START is generated. In response thereto, the stored value of the register 14 is updated from 0 to 1.

At time t2, the event signal SIG_E1 is generated. Just after that, the count up signal SIG_UP1 is output from the selector 11. Then, the count value of the counter 15 is incremented by 1.

At t3, the same operation as the operation at time t2 is executed.

At time t4, the measurement stop signal SIG_STOP is generated. In response to the measurement stop signal SIG_STOP, the stored value of the register 14 is updated from 1 to 0. Then, the count up signal SIG_UP2 is generated. In response to the count up signal SIG_UP2, the count value of the counter 25 is incremented by 1.

The period from time t1 to time t4 corresponds to the period from the start to the end of the first iteration of the measurement target section. Likewise, the period from time t5 to time t7 corresponds to the period from the start to the end of the second iteration of the measurement target section. The period from time t8 to time t12 corresponds to the period from the start to the end of the third iteration of the measurement target section.

At time t5 and t8, the same operation as the operation at time t1 is executed. At time t6, t9, t10 and t11, the same operation as the operation at time t2 is executed. At time t7 and t12, the same operation as the operation at time t4 is executed.

### Second Exemplary Embodiment

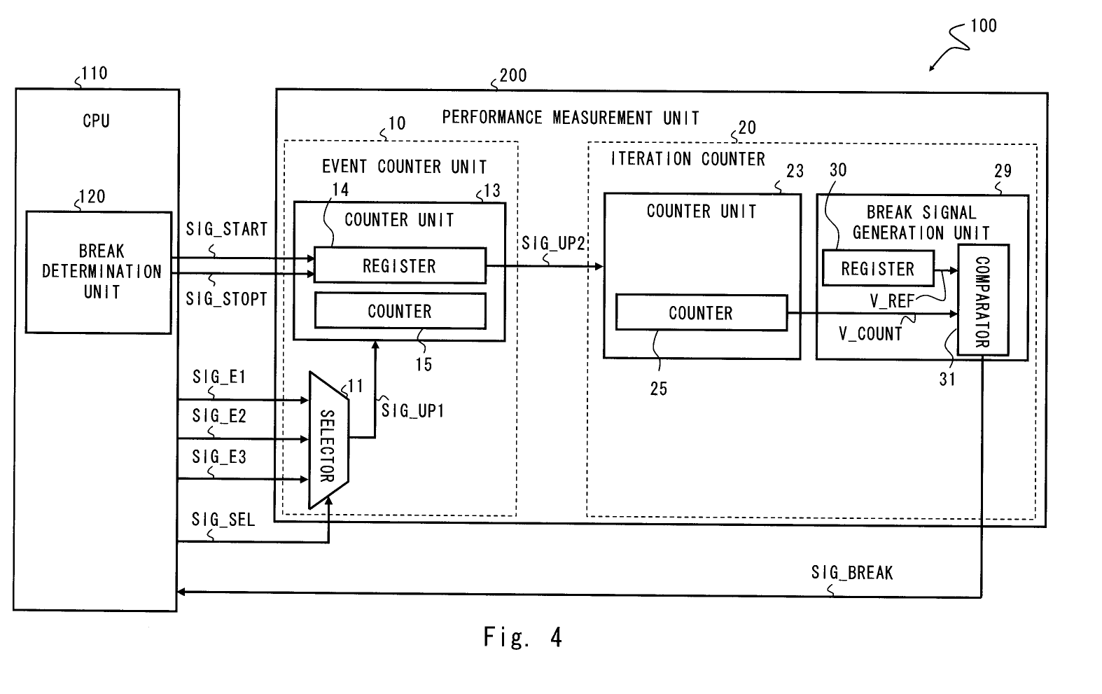

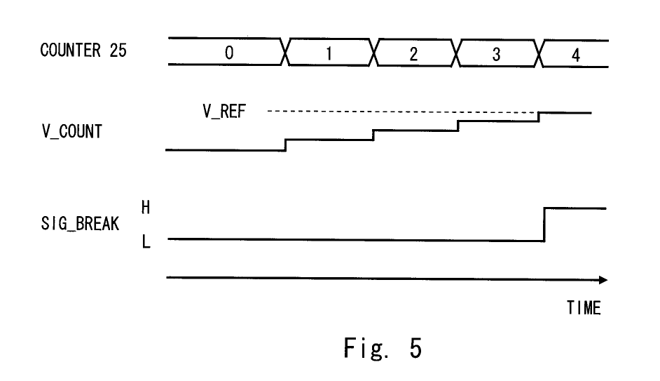

Another exemplary embodiment of the present invention is described hereinafter with reference to the drawings. FIG. 4 is a schematic block diagram of a microprocessor. FIG. 5 is a schematic timing chart showing an operation of the microprocessor.

In this exemplary embodiment, differently from the first exemplary embodiment, the iteration counter unit 20 further includes a break signal generation unit 29. The break signal generation unit 29 includes a register 30 and a comparator 31. An output of the register 30 and an output of the counter 25 are connected to the comparator 31. An output of the comparator 31 is connected to the CPU 110.

When the count value of the counter 25 reaches a predetermined value, the break signal generation unit 29 outputs a break signal SIG_BREAK to the CPU 110. It is thereby possible to detect that the measurement section is executed repeatedly for a predetermined number of iterations. This enables measurement of performance of a program from various points of view under the condition that the number of iterations of the measurement section is a fixed number. It is thereby possible to appropriately evaluate program performance. Note that, an appropriate value is set to the register 30 by the CPU 110.

Referring to FIG. 4, a reference value V_REF is input from the register 30 to a first input terminal of the comparator 31. A count value V_COUNT is input from the counter 25 to a second input terminal of the comparator 31. The comparator 31 compares the two input values and, if they match, generates the break signal SIG_BREAK. Upon input of the break signal SIG_BREAK, the CPU 110 suspends execution of the program or gives notification to the program by means of interrupt or the like, for example.

The above point is additionally described with reference to FIG. 5.

Upon iteration of the measurement section, the count value of the counter 25 is sequentially incremented by 1. Accordingly, the count value V_COUNT output from the counter 25 varies as schematically shown in FIG. 5. When the count value V_COUNT matches the reference value V_REF, the comparator 31 outputs the break signal SIG_BREAK to the CPU 110.

The present invention is not restricted to the above-described embodiment, and various changes and modifications may be made without departing from the scope of the invention. For example, the count values of the counter 15 and the counter 25 may be constantly displayed on a monitor. Further, the history of the counter 15 and the counter 25 may be acquired.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A performance evaluation device comprising:
a first counter unit that counts events occurring by execution of an evaluation target program from arrival of a measurement start signal indicating a measurement start point of a measurement section preset to the evaluation target program to arrival of a measurement stop signal indicating a measurement stop point of the measurement section; and
a second counter unit that counts iterations of the measurement section to be iterated based on at least one of the measurement start signal and the measurement stop signal.

2. The performance evaluation device according to claim 1, wherein the second counter unit counts iterations of the measurement section to be iterated based on a change in a measurement status value having a value corresponding to the measurement start signal and the measurement stop signal.

3. The performance evaluation device according to claim 1, wherein the first counter unit selects an event signal corresponding to a previously selected event among a plurality of event signals notifying occurrence of the events different from one another and counts the selected event signal.

4. The performance evaluation device according to claim 2, wherein the first counter unit comprises:
a register that stores the measurement status value; and
a counter that starts and stops count of an event signal corresponding the event according to a change in the measurement status value.

5. The performance evaluation device according to claim 4, wherein the first counter unit further comprises:
a selector that selects an event signal corresponding to a previously selected event among a plurality of event signals notifying occurrence of the events different from one another.

6. The performance evaluation device according to claim 1, wherein the second counter unit detects that a count value corresponding to the iterations of the measurement section to be iterated has reached a preset value.

7. A semiconductor integrated device comprising:
a central processing unit (CPU) that executes an evaluation target program;
a signal generation unit that generates a measurement start signal and a measurement stop signal by detecting a measurement start point and a measurement stop point of a measurement section preset to the evaluation target program;
a first counter unit that counts events occurring by execution of the evaluation target program from arrival of the measurement start signal to arrival of the measurement stop signal; and
a second counter unit that counts iterations of the measurement section to be iterated based on at least one of the measurement start signal and the measurement stop signal.

8. The semiconductor integrated device according to claim 7, wherein the second counter unit counts iterations of the measurement section to be iterated based on a change in a measurement status value having a value corresponding to the measurement start signal and the measurement stop signal.

9. The semiconductor integrated device according to claim 7, wherein the first counter unit selects an event signal corresponding to a previously selected event among a plurality of event signals notifying occurrence of the events different from one another and counts the selected event signal.

10. The semiconductor integrated device according to claim 8, wherein the first counter unit comprises:
a register that stores the measurement status value; and
a counter that starts and stops count of an event signal corresponding the event according to a change in the measurement status value.

11. The semiconductor integrated device according to claim 10, wherein the first counter unit further comprises:
a selector that selects an event signal corresponding to a previously selected event among a plurality of event signals notifying occurrence of the events different from one another.

12. The semiconductor integrated device according to claim 7, wherein the second counter unit detects that a count value corresponding to the iterations of the measurement section to be iterated has reached a preset value.

13. A performance evaluation method comprising:
counting events occurring by execution of an evaluation target program from arrival of a measurement start signal indicating a measurement start point of a measurement section preset to the evaluation target program to arrival of a measurement stop signal indicating a measurement stop point of the measurement section; and
counting iterations of the measurement section to be iterated based on at least one of the measurement start signal and the measurement stop signal.
